(19) United States
(12) Patent Application Publication
(10) Pub. No.: US 2026/0021841 A1
(43) Pub. Date: Jan. 22, 2026

(54) FOLDING TRAILER

(71) Applicant: Wuyi Shanqiu Leisure Products Co., Ltd., Jinhua (CN)

(72) Inventor: JIANQIU HU, Bozhou (CN)

(21) Appl. No.: 18/808,149

(22) Filed: Aug. 19, 2024

(30) Foreign Application Priority Data
Jul. 17, 2024 (CN) 202421687447.6

(51) Int. Cl. B62B 3/02; B62B 3/00; B62B 5/06

(52) U.S. Cl. CPC B62B 3/02; B62B 3/002; B62B 5/067

(57) ABSTRACT

This invention relates to a folding trailer with a foldable base plate and side panels. The base plate features symmetrical positioning frames on both sides, with two foldable side panels set between them at the front and rear. The base plate consists of two bases connected by a tubular hinge, with their outer ends pivotally attached to the positioning frames. The side panels comprise pivotally connected, foldable X-link assemblies. The outermost X-link assembly ends are fixed to first and second seats, with their upper ends pivotally connected to folding arms. During folding, the rotation of these arms facilitates the process, securing the side panel ends without sliding adjustments, allowing for efficient folding.

### CROSS-REFERENCE TO RELATED APPLICATIONS

This application claims priority to Chinese Patent Application No. 202421687447.6, filed on July 17, 2024, which is hereby incorporated by reference in its entirety.

### TECHNICAL FIELD

This invention relates to the field of carts, particularly to a folding trailer.

### BACKGROUND

A cart (trailer) refers to a type of cart that can be folded to reduce its size for ease of carrying and storage. Lightweight carts for various purposes are generally designed to have a foldable version to enhance portability. These carts are novel and aesthetically pleasing, employing composite plastics for the body and wheels to reduce the overall weight of the vehicle. Unique silent and transmission technology designs make the cart's movement quiet and swift. They are widely suitable for use in factories, office buildings, libraries, hotels, catering businesses, and logistics and material handling.

The technical problems this application aims to solve include: how to make the trailer easy to store, how to simplify the folding process of the trailer, and how to ensure the trailer maintains a neat appearance after folding.

To overcome the shortcomings of existing technologies, the objective of this invention is to provide a folding trailer that is capable of being neatly and orderly stored, has a simple folding mechanism, and maintains a tidy appearance after folding.

The technical solution adopted by this invention involves a folding trailer that includes a folding base plate and folding side panels. The top sides of the folding base plate are symmetrically equipped with positioning frames. The two folding side panels are situated between the two positioning frames and are positioned at the front and rear ends of the positioning frames, respectively. The folding base plate comprises two bases, which are connected by a tubular hinge acting as a connector. The ends of the bases, away from the tubular hinge, are pin-connected to the corresponding positioning frames. The folding side panels consist of several pin-connected, foldable X-link groups. The top ends of the two outermost X-link groups are equipped with folding arms, and their bottom ends are pin-connected to a first fixing seat. The first fixing seat is fitted onto the body of the corresponding positioning frame, and the end of the folding arm is pin-connected to a second fixing seat designed to be fitted onto the body of the positioning frame;

By incorporating two bases connected by a tubular hinge to form a complete folding base plate, this configuration allows the folding base plate to switch between folded and unfolded states. Furthermore, the arrangement includes several pin-connected X-link groups that compose a complete folding side panel, enabling the side panel to transform its shape corresponding to the expansion and contraction of the folding base plate. As the ends of both sides of the folding side panel-specifically, the ends of the two outermost X-link groups-are fixed to the first and second fixing seats, the top ends of these groups are connected by a folding arm. Thus, during folding, the rotation of the folding arm facilitates the folding action, securing the assembly position of the side ends of the folding side panel without the need for sliding adjustments to execute the folding process.

In some embodiments, the bottom of the folding base plate is equipped with four movable wheels, distributed symmetrically in two pairs, front and rear.

In some implementations, two of the symmetric movable wheels are swivel casters capable of steering. The horizontal positions of these swivel casters are parallel to and do not coincide with those of the movable wheels.

In some embodiments, a pull rod is pin-connected to one of the positioning frames.

In some embodiments, the pull rod is a telescopic rod that can be extended or retracted, with a handle at the top.

In some embodiments, the horizontal height of the top of the folded X-link group matches the horizontal height of the top of the positioning frame.

In some embodiments, the width of the folding base plate is less than the distance between the two folding side panels.

In some embodiments, both the first and second fixing seats are fixed to the corresponding positioning frames using screws.

The beneficial effects of this invention include:

By integrating two bases connected by a tubular hinge to form a complete folding base plate, this design enables the folding base plate to switch between folded and unfolded states. Additionally, multiple pin-connected X-link groups compose a complete folding side panel, allowing the side panel to transform its shape in correspondence with the expansion and contraction of the folding base plate. This feature facilitates a structured transformation aligning with the operational dynamics of the base plate.

In this invention, the ends of both sides of the folding side panels, specifically the ends of the two outermost X-link groups, are fixed to the first and second fixing seats. This configuration includes a folding arm pin-connected at the top of these ends. During the folding process, the rotation of the folding arm enables the completion of the folding action, securing the assembly position of the side ends of the folding side panel without the need for sliding adjustments, thus facilitating the folding operation.

### BRIEF DESCRIPTION OF DRAWINGS

FIG. 1 is a three-dimensional schematic diagram of a folding trailer according to this invention.

FIG. 2 is a top view schematic diagram of a folding trailer according to this invention.

FIG. 3 is a three-dimensional schematic diagram of the folding side panel of this invention.

FIG. 4 is a schematic diagram of the folding state of a folding trailer according to this invention.

FIG. 5 is a left view schematic diagram of the base of the invention.

In the figures: 1. Folding base plate; 10. Base; 11. Tubular hinge; 12. Movable wheel; 13. Swivel caster; 2. Folding side panel; 20. X-link group; 21. Folding arm; 22. First fixing seat; 23. Second fixing seat; 3. Positioning frame; 4. Pull rod; 40. Telescopic rod; 41. Handle.

### DETAILED DESCRIPTION OF THE EMBODIMENTS

The following description will elaborate on the technical solutions in the embodiments of the present invention in conjunction with the accompanying drawings. It should be noted that the described embodiments are only some of the embodiments of the invention, not all of them. All other embodiments obtained by persons skilled in the art from this invention, without creative efforts, are within the scope of this invention’s protection.

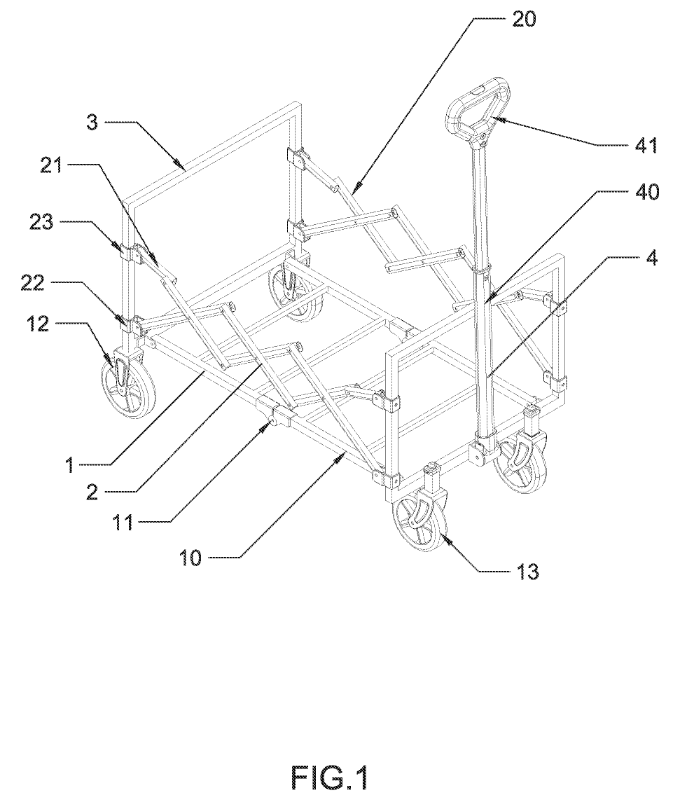

Please refer to FIG. 1, the present invention provides a technical solution: a folding trailer, which includes a folding baseboard 1 and folding side panels 2. The bottom of the folding baseboard 1 is equipped with four movable wheels 12, distributed symmetrically in pairs. Among these, two symmetrical wheels 12 are directional universal wheels 13. The horizontal positions of the universal wheels 13 are parallel to, yet do not coincide with, those of the movable wheels 12. On both sides of the top of the folding baseboard 1, positioning frames 3 are symmetrically arranged. The two folding side panels 2 are positioned between the two positioning frames 3, and are located at the front and back ends of the positioning frames 3, respectively. One of the positioning frames 3 is fitted with a pull rod 4, which is an extendable telescoping rod 40, and the top of the telescoping rod 40 is equipped with a handle 41;

The handle 41 enables the user to pull the telescoping rod 40, which can extend and also rotate around its pivot point at the base. This feature allows for quick and easy maneuvering using the handle 41 to pull the rod 4, thereby causing the folding baseboard 1 to move. After folding, the positions of the universal wheels 13 do not coincide with those of the movable wheels 12, thus preventing interference between the universal wheels 13 and the movable wheels 12, which could complicate complete folding;

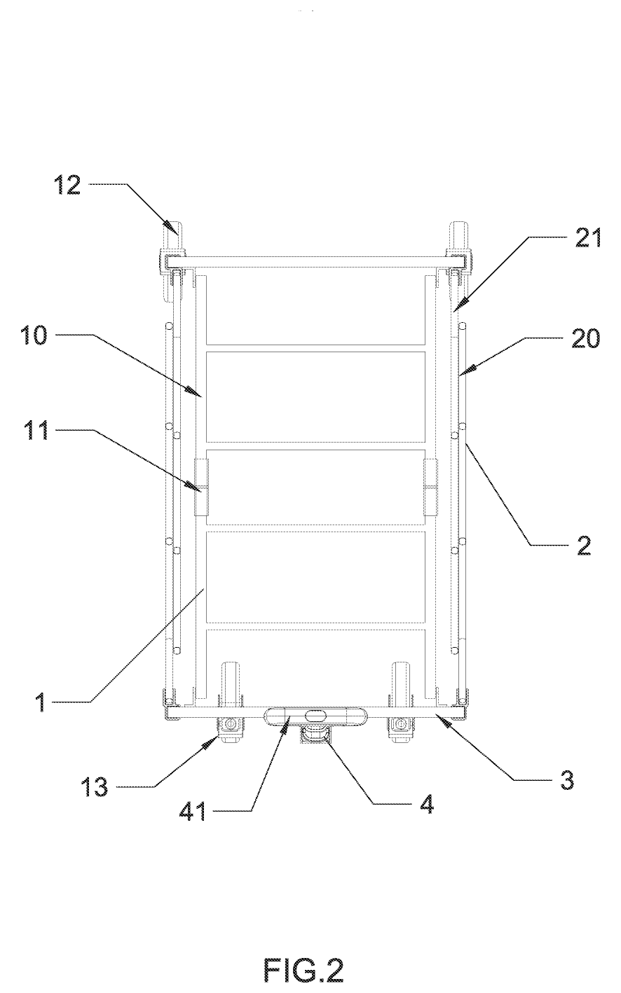

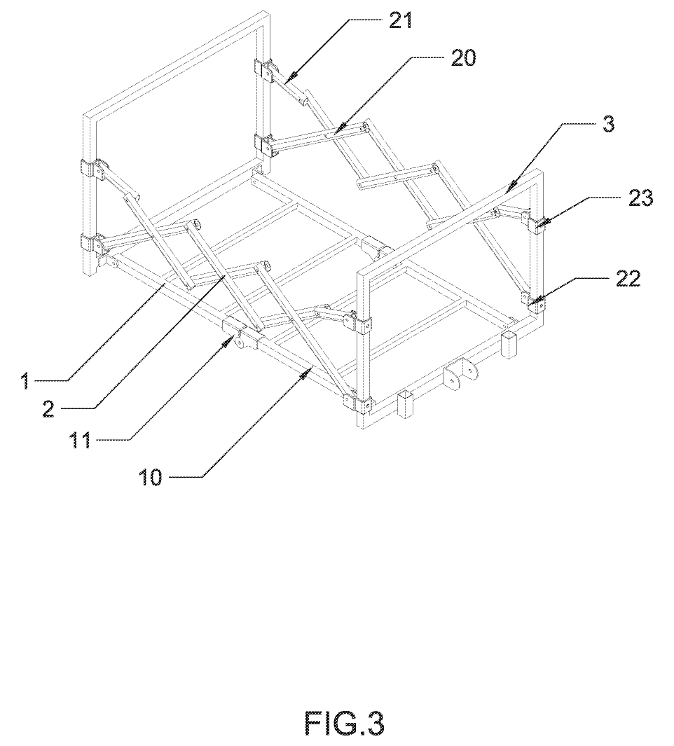

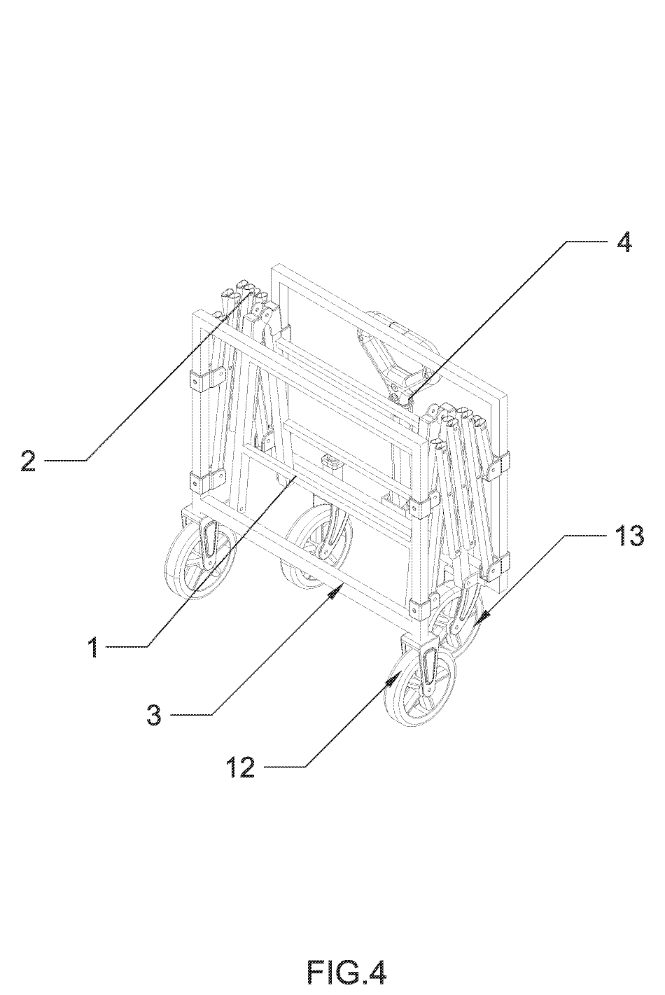

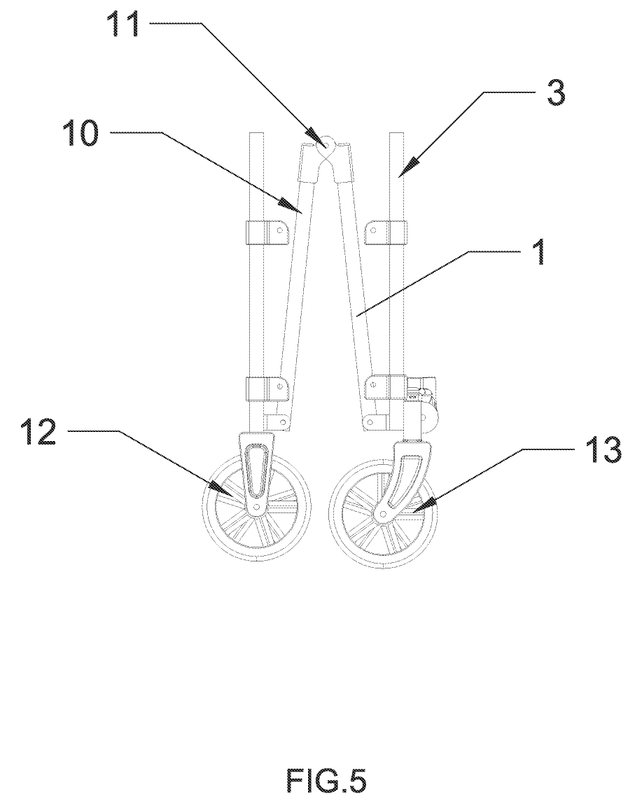

Please refer to FIGS. 1 through 5. The folding baseboard 1 includes two bases 10, which are interconnected by a tubular hinge 11. At one end away from the tubular hinge 11, each base 10 is pivotally connected to the corresponding positioning frame 3;

The arrangement of the two bases 10 connected by the tubular hinge 11 forms a complete folding baseboard 1, allowing the folding baseboard 1 to switch between folded and unfolded states.

Please refer to FIGS. 1 to 5. The folding side panel 2 includes several pivotally connected, foldable X-link assemblies 20. At the ends of the two X-link assemblies 20 positioned at the outermost sides, there are folding arms 21 at the top and first mounting bases 22 at the bottom, which are pivotally connected. The first mounting base 22 is mounted on the frame of the corresponding positioning frame 3. The ends of the folding arms 21 are connected to a second mounting base 23, which is designed to fit over the frame of the positioning frame 3; After folding, the top horizontal height of the X-link assembly 20 aligns with the top horizontal height of the positioning frame 3. The width of the folding baseboard 1 is less than the distance between the two folding side panels 2. Both the first and second mounting bases, 22 and 23 respectively, are fixed to the corresponding positioning frames 3 with screws;

The folding side panel 2 is composed of multiple pivotally connected X-link assemblies 20, forming a complete unit. This configuration allows the folding side panel 2 to transform its shape corresponding to the expansion and contraction of the folding baseboard 1. Since the ends of the X-link assemblies 20 at both lateral ends of the folding side panel 2 are fixed to the first and second mounting bases, 22 and 23 respectively, and the top ends of these assemblies are connected to folding arms 21, the folding action can be completed through the rotation of these arms during the folding process. This ensures that the side ends of the folding side panel 2 are fixed in place without the need for sliding adjustments, facilitating the folding operation.

Working Principle and Usage Process of the Invention: Initially, the handle 41 is used to pull the telescoping rod 40, which not only extends but can also rotate around its pivot at the base. This allows for easy and efficient maneuvering by pulling on the handle 41 to move the folding baseboard 1;

Subsequently, by pulling on the positioning frame, the two bases can rotate around the tubular hinge , transitioning the folding baseboard from a folded state to an unfolded state. As the bases rotate, the X-link assemblies continuously unfold through their pivot points. For the X-link assemblies located at the far left and right sides, the bottom of these assemblies is fixed to the positioning frame via the first mounting base. At the same time, the top of these X-link assemblies is first pivotally connected to a folding arm, which is then fixed to the positioning frame through the second mounting base. The rotation of the folding arm replaces the need for sliding movement at the ends of the X-link assemblies, allowing the fixed ends of the folding side panel to unfold without changing position. This mechanism reduces the jerking motion often associated with folding actions, ensuring a smoother folding process and minimizing wear from sliding, thereby extending the product's lifespan.

It should be noted that the above descriptions are merely preferred examples of the invention and are not intended to limit the scope of the invention. Despite the detailed explanation of the invention with reference to the aforementioned embodiments, those skilled in the art can still modify the technical solutions described in these embodiments or make equivalent substitutions for some of the technical features. Any modifications, equivalent substitutions, or improvements made within the spirit and principles of the invention should be included within the scope of protection of this invention.

What is claimed is:

1. A folding trailer, which includes a folding base plate and foldable side panels. Characteristically, the folding base plate has positioning frames symmetrically arranged on both sides of its top. Two foldable side panels are located between the two positioning frames, with each panel situated at the front and rear ends of these frames;
The folding base plate consists of two bases connected by a tubular hinge that acts as a connector. The ends of the bases that are distanced from the tubular hinge are pivotally connected to the corresponding positioning frames;
The foldable side panels include several pivotally connected, foldable X-link assemblies. At the top of the outermost X-link assemblies, there are folding arms and at the bottom, each is pivotally connected to a first fixed seat. The first fixed seat is fitted onto the corresponding positioning frame. The ends of the folding arms are pivotally connected to a second fixed seat, which is designed to be mounted onto the frame of the positioning frame. This design allows for efficient folding and securing of the trailer's components.

2. The folding trailer according to claim 1, wherein the folding base plate is equipped with four movable wheels at the bottom, distributed symmetrically in two pairs, front and rear.

3. The folding trailer according to claim 2, wherein two of the symmetric movable wheels are steering-capable swivel casters, with the horizontal positions of the swivel casters parallel to and not coinciding with those of the movable wheels.

4. The folding trailer according to claim 1, wherein one of the positioning frames is pin-connected with a pull rod.

5. The folding trailer according to claim 4, wherein the pull rod is a telescopic rod capable of extending and retracting, and the top of the telescopic rod is equipped with a handle.

6. The folding trailer according to claim 1, wherein the horizontal height of the top of the folded X-link group is consistent with the horizontal height of the top of the positioning frame.

7. The folding trailer according to claim 1, wherein the width of the folding base plate is smaller than the distance between the two folding side panels.

8. The folding trailer according to claim 1, wherein both the first fixing seat and the second fixing seat are fixed onto the corresponding positioning frame using screws.
